(19) United States
(12) Patent Application Publication
(10) Pub. No.: US 2021/0388135 A1
(43) Pub. Date: Dec. 16, 2021

(54) COPOLYMERS OF VINYL CHLORIDE, VINYL ACETATE AND LONG-CHAIN VINYL ESTERS

(71) Applicants: WACKER CHEMIE AG, Munich (DE); VINNOLIT GMBH & CO. KG, Ismaning (DE)

(72) Inventors: Ulrich LAUTER, Burghausen (DE); Stefan BAUEREGGER, Trostberg (DE)

(73) Assignees: WACKER CHEMIE AG, Munich (DE); VINNOLIT GMBH & CO. KG, Ismaning (DE)

(21) Appl. No.: 16/637,341

(22) PCT Filed: Aug. 7, 2017
(86) PCT No.: PCT/EP2017/069948

§ 371 Date: Feb. 7, 2020

(51) Int. Cl. C08F 214/06; C08F 218/08; C08F 222/06; C08F 2/18; C08F 222/02; C08F 220/18; C09D 127/06

(52) U.S. Cl. CPC C08F 214/06; C08F 218/08; C08F 222/06; C09D 127/06; C08F 222/02; C08F 220/1812; C08F 2/18

(57) ABSTRACT

Copolymers of vinyl acetate, vinyl chloride, and vinyl esters of long chain carboxylic acids are soluble in low polarity organic solvents, and produce superior binder and seam-sealing compositions. The copolymers contain 50-75 wt. % vinyl chloride, 5-25 wt. % vinyl acetate, and 10-55 wt. % vinyl ester of long-chain carboxylic acid.

### CROSS REFERENCE TO RELATED APPLICATIONS

This application is the U.S. National Phase of PCT Appln. No. PCT/EP2017/069948 filed Aug. 7, 2017, the disclosure of which is incorporated in its entirety by reference herein.

### BACKGROUND OF THE INVENTION

### 1. Field of the Invention

The invention relates to copolymers of vinyl chloride, vinyl acetate and one or more long-chain vinyl esters of unbranched or branched alkylcarboxylic acids having 3 to 18 carbon atoms, to their preparation by free radical polymerization, and to the use of the copolymers accordingly obtained.

### 2. Description of the Related Art

Copolymers of vinyl chloride and vinyl esters are known from the prior art and are used in all sorts of applications: as binders for paints and printing inks; for impregnating and coating paper, card, textiles, nonwovens, metals, mineral surfaces, wood, and plastics; as coating materials for producing heat-sealable and RF-weldable films.

Published specification DE 1 745 555 relates to a process for preparing aqueous dispersions of copolymers of vinyl chloride, vinyl acetate and long-chain vinyl ester. To improve the stability of the aqueous dispersions and of the polymer films obtained with these copolymers, it is proposed that the preparation take place using a ternary dispersant mixture composed of protective colloid, anionic emulsifier and nonionic emulsifier. The laid-open specification DE 1 745 563 recommends preparing such copolymers with a ternary dispersant mixture composed of polyvinyl pyrrolidone, hydroxyalkylcellulose and nonionic emulsifier.

The laid-open specification DE 2 206 593 recommends improving the properties of vinyl chloride-vinyl acetate copolymers by likewise using a specific dispersant, namely cellulose ethers in combination with esters or ketones. Laid-open specification DE 2 409 800 describes the improvement in the metal adhesion in the case of vinyl chloride-vinyl acetate copolymers through copolymerization of unsaturated carboxylic acids.

The subject of laid-open specification DE 2 364 057 is the improvement in the solubility and thermal stability of bulk polymers of vinyl chloride and maleic anhydride through copolymerization of a vinyl ester such as, for example, vinyl acetate. EP 0 177 956 A2 describes the improvement in processability of vinyl chloride polymers through copolymerization of long-chain vinyl esters, where the vinyl ester is copolymerized to lower the melt viscosity, and the molecular weight is lowered using mercaptan chain transfer agents. It is known from EP 0 391 398 A1 that the thermal stability of vinyl chloride-vinyl acetate copolymers is improved through replacement of the vinyl acetate with vinyl ester of Versatic acid.

Patent EP 1 599 515 B1 describes the preparation of thermally stable vinyl chloride copolymers through copolymerization with epoxide-containing comonomers and in the presence of hydroxy-carboxylic acids.

The presently obtainable vinyl chloride-vinyl acetate copolymers exhibit, when being processed, an unsatisfactory solubility in solvents of relatively low polarity such as aromatics, glycol esters, or glycol ethers. Desirable, furthermore, is an improvement in adhesion to metal surfaces, aluminum for example, or plastics surfaces. The water resistance of coatings and the seal seam strength of composite materials which are obtained with the presently available vinyl chloride-vinyl acetate copolymers are likewise in need of improvement.

### SUMMARY OF THE INVENTION

The invention is directed to copolymers of vinyl chloride, vinyl acetate and one or more long-chain vinyl esters of unbranched or branched alkylcarboxylic acids having 3 to 18 carbon atoms, characterized in that they comprise 35 to 80 wt % of vinyl chloride monomer units, 1 to 30 wt % of vinyl acetate monomer units and 10 to 64 wt % of monomer units of long-chain vinyl esters, the figures in wt % being based on the total weight of the comonomers, and the figures in wt % adding up in each case to 100 wt %.

### DETAILED DESCRIPTION OF THE PREFERRED EMBODIMENTS

Preferred are copolymers with 50 to 75 wt % of vinyl chloride monomer units, 5 to 25 wt % of vinyl acetate monomer units and 10 to 55 wt % of monomer units of long-chain vinyl esters. Particularly preferred are copolymers with 55 to 75 wt % of vinyl chloride monomer units, 5 to 25 wt % of vinyl acetate monomer units and 10 to 30 wt % of vinyl laurate.

Preferred long-chain vinyl esters of unbranched or branched alkyl carboxylic acids having 3 to 18 carbon atoms are vinyl propionate, vinyl butyrate, vinyl 2-ethylhexanoate, vinyl laurate, 1-methylvinyl acetate, and vinyl esters of α-branched monocarboxylic acids having 5 to 13 carbon atoms, examples being vinyl pivalate, VeoVa9®, VeoVa10® or VeoVa11® (trade names of Hexion). Particularly preferred are vinyl laurate (trade name of Wacker Chemie is Versa® 12) and vinyl esters of α-branched monocarboxylic acids having 9 to 10 carbon atoms (VeoVa9® and VeoVa10®). The most preferred is vinyl laurate (vinyl dodecanoate).

Optionally it is possible additionally for up to 10 wt %, preferably 0.1 to 10 wt %, more preferably 0.1 to 2.0 wt % of functional comonomers to be copolymerized. Examples of functional comonomers are ethylenically unsaturated monocarboxylic and dicarboxylic acids, preferably acrylic acid, methacrylic acid, fumaric acid, itaconic acid, crotonic acid and maleic acid, and also maleic anhydride; ethylenically unsaturated carboxamides and carbonitriles, preferably acrylamide and acrylonitrile; ethylenically unsaturated sulfonic acids and/or salts thereof, preferably vinylsulfonic acid, 2-acrylamido-2-methylpropanesulfonic acid; epoxide-containing comonomers such as glycidyl methacrylate, glycidyl acrylate, allyl glycidyl ether, vinyl glycidyl ether, preferably glycidyl methacrylate.

The figures in wt % here are based on the total weight of the comonomers and add up in each case to 100 wt %.

The copolymers are prepared by radically initiated polymerization in bulk, or in nonaqueous solvents, or in aqueous medium, by means of suspension polymerization, emulsion polymerization, microsuspension polymerization or miniemulsion polymerization. In the case of solution polymerization, organic solvents such as ethyl acetate or acetone are used. Preferred are the polymerization processes in aqueous medium, and particularly preferred are suspension polymerization and emulsion polymerization. The polymerization temperature is in general 20° C. to 85° C. The polymerization may be initiated with the water-soluble or monomer-soluble initiators, or redox initiator combinations, that are customary for the particular polymerization process. These initiators/combinations are known to the skilled person. These initiators are used in general in an amount from 0.01 to 1.0 wt %, preferably 0.1 to 0.5 wt %, based in each case on the total weight of the comonomers.

The processes of suspension and emulsion polymerization that are stated as particularly preferred involve polymerizing in water in the presence of surface-active substances such as protective colloids and/or emulsifiers. Suitable protective colloids are, for example, partially saponified and fully saponified polyvinyl alcohols, celluloses and their carboxy-methyl, methyl, hydroxyethyl, hydroxypropyl derivatives, starch and starch derivatives, copolymers of alkyl (meth)acrylates and OH-alkyl (meth)acrylates. Preferred polyvinyl alcohols are partially saponified polyvinyl alcohols having a degree of hydrolysis of 70 to 95 mol % and a Höppler viscosity in 4% aqueous solution of 1 to 30 mPas (Höppler method at 20° C., DIN 53015). Preferred cellulose ethers are hydroxypropyl-methylcelluloses. Preferably no polyvinylpyrrolidone is used. Suitable emulsifiers are anionic, cationic and nonionic emulsifiers, examples being anionic surfactants such as alkyl sulfates having a chain length of 8 to 18 carbon atoms, alkyl- or alkylarylsulfonates having 8 to 18 carbon atoms, full esters and monoesters of sulfosuccinic acid with monohydric alcohols or alkylphenols, or nonionic surfactants such as alkyl polyglycol ethers or alkylaryl polyglycol ethers having up to 60 ethylene oxide and/or propylene oxide units. In general from 0.05 to 5 wt % of protective colloids and/or emulsifiers is used, based on the total weight of the comonomers.

To regulate the molecular weight it is possible to use chain transfer substances during the polymerization. If chain transfer agents are used, they are typically employed in amounts between 0.02 to 10.0 wt %, based on the monomers to be polymerized, and are metered separately or else as a premix with reaction components. Examples of such substances are halogenated alkanes and halogenated alkenes such as carbon tetrachloride, chloroform, methyl chloride, trichloroethylene, and also aldehydes such as acetaldehyde, propionaldehyde, butyraldehyde and isobutyraldehyde. Also suitable are mercaptans. Propionaldehyde is preferred.

The monomers can be metered in entirely or introduced initially in fractions, with the remainder metered in after the polymerization has been initiated. The metered additions may be carried out separately (spatially and temporally). After the end of the polymerization, residual monomers may be removed by postpolymerization using known techniques, such as, for example, by postpolymerization initiated with redox catalyst. Volatile residual monomers may also be removed by distillation, preferably under reduced pressure, and optionally with inert entraining gases such as air, nitrogen or steam being passed through or over the reactor contents.

The copolymer may be isolated from an aqueous dispersion or nonaqueous solution through typical processes, as for example by precipitation, filtration and subsequent drying, or by decanting and subsequent drying, in the form of the solid resin. Drying may be accomplished in a way known to the skilled person, for example, in a drum dryer, in a flow tube, in a fluidized bed, or in a cyclone dryer.

The copolymers are suitable as binders for paints and printing inks; as binders in coating materials for impregnating and coating paper, card, textiles, nonwovens, metals, mineral surfaces, wood, and plastics; and as coating materials for producing heat-sealable and RF-weldable films.

It should be emphasized that the copolymers not only dissolve in the ketones and esters that are frequently used as solvents, but are also readily soluble, even at room temperature (23° C.), in solvents that are less suitable for vinyl chloride-vinyl acetate copolymers, such as aromatics, glycol esters, or glycol ethers, without heating. Further qualities to be emphasized are the improved miscibility with other binders of relatively low polarity, and the improved adhesion to substrates of relatively low polarity.

The examples which follow serve for further elucidation of the invention.

### Preparation of the Copolymers

### Comparative Example 1

Introduced initially in a 40 L autoclave were 12.5 kg of water and 17.5 g of dilauroyl peroxide. After the autoclave had been rendered inert using nitrogen, 1.25 kg of vinyl chloride and 0.93 kg of vinyl acetate were placed into the autoclave and the mixture was stirred for 30 minutes. To stabilize the droplets, 1.93 kg of a 3.05 wt % hydroxypropylmethylcellulose (HPMC) solution in water were added. The reaction mixture was then heated to the polymerization temperature of 74° C. and thereafter the metered addition of a mixture of 10.3 kg of vinyl chloride and 1.3 kg of vinyl acetate was commenced at constant pressure. The polymerization was ended when a final pressure of 4.0 bar was reached. After the working-up of the suspension (degassing, washing and drying), a white powder was isolated.

### Comparative Example 2

Introduced initially in a 40 L autoclave were 15.4 kg of water and 16.2 g of dilauroyl peroxide. After the autoclave had been rendered inert using nitrogen, 8.24 kg of vinyl chloride and 5.30 kg of vinyl acetate were placed into the autoclave and the mixture was stirred for 20 minutes. To stabilize the droplets, 1.34 kg of a 3.05 wt % hydroxypropylmethylcellulose (HPMC) solution in water were added. The reaction mixture was then heated to the polymerization temperature of 71° C. The polymerization was ended when a final pressure of 0.5 bar was reached. After the working-up of the suspension (degassing, washing and drying), a white powder was isolated.

### Inventive Example 1

Introduced initially in a 40 L autoclave were 15.7 kg of water and 38.3 g of dilauroyl peroxide. After the autoclave had been rendered inert using nitrogen, 4.25 kg of vinyl chloride, 3.54 kg of vinyl acetate, 0.7 kg of vinyl laurate and 14.2 g of propanal were placed into the autoclave and the mixture was stirred for 20 minutes. To stabilize the droplets, 1.39 kg of a 3.05 wt % hydroxypropylmethylcellulose (HPMC) solution in water were added. The reaction mixture was then heated to the polymerization temperature of 71° C. and thereafter the metered addition of 5.7 kg of vinyl chloride was commenced at constant pressure. The polymerization was ended on a drop in pressure of 3.5 bar in comparison to the initial pressure. After the working-up of the suspension (degassing, washing and drying), a white powder was isolated.

### Inventive Example 2

Introduced initially in a 40 L autoclave were 15.7 kg of water and 28.4 g of dilauroyl peroxide. After the autoclave had been rendered inert using nitrogen, 4.96 kg of vinyl chloride, 2.13 kg of vinyl acetate, and 1.40 kg of vinyl laurate were placed into the autoclave and the mixture was stirred for 20 minutes. To stabilize the droplets, 1.39 kg of a 3.05 wt % hydroxypropylmethylcellulose (HPMC) solution in water were added. The reaction mixture was then heated to the polymerization temperature of 71° C. and thereafter the metered addition of 5.62 kg of vinyl chloride was commenced at constant pressure. The polymerization was ended on a drop in pressure of 3.5 bar in comparison to the initial pressure. After the working-up of the suspension (degassing, washing and drying), a white powder was isolated.

### Inventive Example 3

Introduced initially in a 40 L autoclave were 15.7 kg of water and 32.6 g of dilauroyl peroxide. After the autoclave had been rendered inert using nitrogen, 4.25 kg of vinyl chloride, 2.13 kg of vinyl acetate, and 2.13 kg of vinyl laurate were placed into the autoclave and the mixture was stirred for 20 minutes. To stabilize the droplets, 1.39 kg of a 3.05 wt % hydroxypropylmethylcellulose (HPMC) solution in water were added. The reaction mixture was then heated to the polymerization temperature of 71° C. and thereafter the metered addition of 5.6 kg of vinyl chloride was commenced at constant pressure. The polymerization was ended on a drop in pressure of 3.5 bar in comparison to the initial pressure. After the working-up of the suspension (degassing, washing and drying), a white powder was isolated.

### Inventive Example 4

Introduced initially in a 40 L autoclave were 15.7 kg of water and 28.4 g of dilauroyl peroxide. After the autoclave had been rendered inert using nitrogen, 5.6 kg of vinyl chloride, 2.1 kg of vinyl acetate, and 2.1 kg of vinyl laurate were placed into the autoclave and the mixture was stirred for 20 minutes. To stabilize the droplets, 1.39 kg of a 3.05 wt % hydroxypropyl-methylcellulose (HPMC) solution in water were added. The reaction mixture was then heated to the polymerization temperature of 71° C. and thereafter the metered addition of 4.3 kg of vinyl chloride was commenced at constant pressure. The polymerization was ended on a drop in pressure of 3.5 bar in comparison to the initial pressure. After the working-up of the suspension (degassing, washing and drying), a white powder was isolated.

### Inventive Example 5

Introduced initially in a 40 L autoclave were 15.7 kg of water and 32.6 g of dilauroyl peroxide. After the autoclave had been rendered inert using nitrogen, 4.25 kg of vinyl chloride, 2.13 kg of vinyl acetate, and 2.13 kg of vinyl laurate were placed into the autoclave and the mixture was stirred for 20 minutes. To stabilize the droplets, 1.39 kg of a 3.05 wt % hydroxypropylmethylcellulose (HPMC) solution in water were added. The reaction mixture was then heated to the polymerization temperature of 71° C. and thereafter the metered addition of 5.6 kg of vinyl chloride was commenced at constant pressure. The polymerization was ended at a pressure drop of 3.3 bar by addition of 15 g of sodium nitrite. After the working-up of the suspension (degassing, washing and drying), a white powder was isolated.

### Inventive Example 6

Introduced initially in a 40 L autoclave were 15.7 kg of water and 32.6 g of dilauroyl peroxide. After the autoclave had been rendered inert using nitrogen, 3.9 kg of vinyl chloride, 1.1 kg of vinyl acetate, 2.1 kg of vinyl laurate and 14.2 g of propanal were placed into the autoclave and the mixture was stirred for 20 minutes. To stabilize the droplets, 1.39 kg of a 3.05 wt % hydroxypropylmethylcellulose (HPMC) solution in water were added. The reaction mixture was then heated to the polymerization temperature of 71° C. and thereafter the metered addition of a mixture of 6.0 kg of vinyl chloride and 1.0 kg of vinyl acetate was commenced at constant pressure. The polymerization was ended on a drop in pressure of 3.5 bar in comparison to the initial pressure. After the working-up of the suspension (degassing, washing and drying), a white powder was isolated.

### Inventive Example 7

Introduced initially in a 40 L autoclave were 15.7 kg of water and 49.6 g of dilauroyl peroxide. After the autoclave had been rendered inert using nitrogen, 3.54 kg of vinyl chloride, 2.13 kg of vinyl acetate, and 2.8 kg of vinyl laurate were placed into the autoclave and the mixture was stirred for 20 minutes. To stabilize the droplets, 1.39 kg of a 3.05 wt % hydroxypropylmethylcellulose (HPMC) solution in water were added. The reaction mixture was then heated to the polymerization temperature of 71° C. and thereafter the metered addition of 5.6 kg of vinyl chloride was commenced at constant pressure. The polymerization was ended on a drop in pressure of 3.5 bar in comparison to the initial pressure. After the working-up of the suspension (degassing, washing and drying), a white powder was isolated.

### Inventive Example 8

Introduced initially in a 40 L autoclave were 20.9 kg of water and 4.84 g of potassium persulfate. After the autoclave had been rendered inert using nitrogen, 1.3 kg of vinyl chloride, 354.4 g of vinyl acetate, 708.8 g of vinyl laurate and 6.41 g of sodium dioctylsulfosuccinate were placed into the autoclave and the mixture was stirred for 20 minutes. The reaction mixture was then heated to the polymerization temperature of 70° C. and thereafter the metered addition of a mixture of 6.96 kg of vinyl chloride, 1.42 kg of vinyl acetate, 0.92 kg of vinyl laurate and 90.90 g of sodium dioctylsulfosuccinate was commenced at constant pressure. The polymerization was ended on a drop in pressure of 1.0 bar in comparison to the initial pressure. After the working-up of the latex (degassing, precipitation, washing and drying), a white powder was isolated.

### Inventive Example 9

Introduced initially in a 40 L autoclave were 15.7 kg of water, 42.5 g of dilauroyl peroxide and 425 g of maleic acid. After the autoclave had been rendered inert using nitrogen, 4.25 kg of vinyl chloride, 2.13 kg of vinyl acetate, and 2.1 kg of vinyl laurate were placed into the autoclave and the mixture was stirred for 20 minutes. To stabilize the droplets, 1.39 kg of a 3.05 wt % hydroxypropylmethylcellulose (HPMC) solution in water were added. The reaction mixture was then heated to the polymerization temperature of 71° C. and thereafter the metered addition of 5.7 kg of vinyl chloride was commenced at constant pressure. The polymerization was ended on a drop in pressure of 3.5 bar in comparison to the initial pressure. After the working-up of the suspension (degassing, washing and drying), a white powder was isolated.

### Measurement Methods:

The polymer composition specified in table 1 was ascertained by means of 1H NMR spectroscopy.

### K Value:

The K value is a metric which correlates with the viscosimetric average molar mass of the polymer. The K value was determined using the method of DIN EN ISO 1628-2.

### Glass Transition Temperature Tg:

The glass transition temperature Tg was determined by DSC (dynamic scanning calorimetry, DIN EN ISO 11357-1/2) using the DSC1 dynamic scanning calorimeter from Mettler-Toledo in an open crucible at a heating rate of 10 K/min. The temperature evaluated as the glass transition temperature was the temperature at the midpoint of the step (midpoint=half step height of the heat flow step) of the second heating curve in the heat flow diagram.

The copolymers obtained in the examples are summarized in table 1:

TABLE 1

| | Polymer composition | | | | | |
|---|---|---|---|---|---|---|
| | VC | VAC | VL | MA | | |
| | fraction | fraction | fraction | fraction | | Tg |
| Sample | [wt %] | [wt %] | [wt %] | [wt %] | K value | [° C.] |
| Comp. Ex. 1 | 85.0 | 15.0 | | | 50.0 | 70 |
| Comp. Ex. 2 | 63.0 | 37.0 | | | 50.0 | 60 |
| Inv. Ex. 1 | 69.8 | 24.2 | 6.0 | | 48.5 | 58 |
| Inv. Ex. 2 | 71.4 | 16.3 | 12.3 | | 50.7 | 52 |
| Inv. Ex. 3 | 70.2 | 13.0 | 16.8 | | 50.4 | 46 |
| Inv. Ex. 4 | 69.8 | 12.5 | 17.7 | | 49.7 | 45 |
| Inv. Ex. 5 | 67.9 | 14.0 | 18.1 | | 47.1 | 43 |
| Inv. Ex. 6 | 60.4 | 20.2 | 19.4 | | 48.8 | 41 |
| Inv. Ex. 7 | 64.1 | 14.4 | 21.5 | | 54.6 | 38 |
| Inv. Ex. 8 | 73.4 | 13.8 | 12.8 | | 53.8 | 53 |
| Inv. Ex. 9 | 69.7 | 11.6 | 16.9 | 1.8 | 48.1 | 50 |

### Performance Tests:

### Preparation of a Varnish Solution and Determination of Solution Haze (Method A):

120 g of xylene were placed in a 250 ml glass bottle and 30 g of the copolymer to be dissolved were metered in slowly with stirring using a high-speed stirrer (dissolver) at 2000 revolutions per minute. After a stirring time of 20 minutes at 2000 rpm, the solution was heated in a water bath to 50° C. with stirring at only 50 revolutions per minute for 30 minutes, after which it was left to cool to 23° C. without stirring.

The solubility was evaluated by carrying out a visual clarity determination.

### Evaluation Scale of the Visual Clarity Determination [Rating]:

1=clear solution
2=almost clear solution
3=slight haze
4=haze
5=great haze
6=insoluble

The results of the clarity determination in xylene are summarized in table 2.

TABLE 2

| | Comp. | Comp. | Inv. | Inv. | Inv. | Inv. | Inv. | Inv. |
|---|---|---|---|---|---|---|---|---|
| Sample | Ex. 1 | Ex. 2 | Ex. 2 | Ex. 3 | Ex. 4 | Ex. 5 | Ex. 6 | Ex. 7 |
| Clarity | 6 | 6 | 3 | 2 | 4 | 2 | 2 | 1 |

Table 2 indicates the improved solubility of the polymers of the invention in xylene, an important representative of apolar solvents.

### Determination of the Seal Seam Strength of Coatings on Aluminum:

In analogy to method A, a 20 wt % solution was prepared from in each case 6 g of the terpolymer Vinnol® H 15/45 M (carboxyl-functional terpolymer of 84 wt % VC and 15 wt % VA and 1 wt % unsaturated dicarboxylic acid; film-forming resin from Wacker Chemie AG) and 24 g of the samples from the inventive examples and comparative examples in 120 g of methyl ethyl ketone.

These solutions were each drawn down to form a bubble-free film on a soft aluminum foil (38 μm thickness) using a 24 μm wire doctor. After a venting time of 10 minutes at room temperature, the coated aluminum foil was dried in a drying cabinet at 180° C. for 15 seconds.

The coated foil was folded in the middle, and then the respectively varnished sides of the foil were sealed to one another using a heat contact heat sealer.

### Sealing Conditions:

a) Time: 0.5 s
b) Temperature of the two sealing jaws (dimensions 15×1 cm): 180° C.
c) Pressure: 30 N/cm²

Five strips (each 1.5 cm wide) were cut from each sealed foil. The seal seam strength was measured by means of a tensile testing apparatus at a removal angle of 90° and a velocity of 100 mm/min. The mean was formed from the 5 tests each of one sealing; the result was reported in N/15 mm.

The values for wet seal seam strength were ascertained in each case after wet storage of the sealed strips in water at 23° C. over 24 hours. The higher the values in N/15 mm, the better the seal seam strength.

The results are summarized in table 3:

TABLE 3

| | Seal seam strength | Wet seal seam strength |
|---|---|---|
| Sample | [N/15 mm] | [N/15 mm] |
| Comp. Ex. 1 | 7.4 | 5.2 |
| Comp. Ex. 2 | 2.5 | 1.8 |
| Inv. Ex. 1 | 8.6 | 8.7 |
| Inv. Ex. 2 | 10.6 | 6.7 |
| Inv. Ex. 3 | 12.6 | 11.3 |
| Inv. Ex. 4 | 12.9 | 12.4 |
| Inv. Ex. 5 | 8.2 | 8.5 |
| Inv. Ex. 6 | 11.2 | 10.8 |
| Inv. Ex. 7 | 7.9 | 8.4 |

From table 3 it can be seen that the polymers of the invention enable an increase in the seal seam strength of composite materials (such as, for instance, coated aluminum, for packaging of foods or drugs, for example). This also shows one way of increasing the water resistance of coatings (on aluminum, for instance).

1.-10. (canceled)

11. A vinyl chloride, vinyl acetate and long-chain vinyl ester copolymer, comprising:
50 to 75 wt % of vinyl chloride monomer units, 5 to 25 wt. % of vinyl acetate monomer units, and 10 to 55 wt. of monomer units of long-chain vinyl esters of unbranched or branched alkylcarboxylic acids having 3 to 1.8 carbon atoms, the figures in wt. % being based on the total weight of the comonomers, and adding up in each case to 100 wt. %.

12. The copolymer of claim 11, wherein long-chain vinyl esters copolymerized comprise vinyl laurate and/or vinyl esters of α-brandied monocarboxylic acids having 9 to 10 carbon atoms.

13. The copolymer of claim 11, comprising 55 to 75 wt. % of vinyl chloride monomer units, 5 to 25 wt. % of vinyl acetate monomer units, and 10 to 30 wt. % of vinyl laurate monomer units.

14. The copolymer of claim 11, further comprising up to 10 wt % of one or more functional comonomers selected from the group consisting of ethylenically unsaturated monocarboxylic and dicarboxylic acids, maleic anhydride, ethylenically unsaturated carboxamides and carbonitriles, ethylenically unsaturated sulfonic acids and salts thereof, epoxide-containing comonomers.

15. The copolymer of claim 12, further comprising up to 10 wt % of one or more functional comonomers selected from the group consisting of ethylenically unsaturated monocarboxylic and dicarboxylic acids, maleic anhydride, ethylenically unsaturated carboxamides and carbonitriles, ethylenically unsaturated sulfonic acids and salts thereof, epoxide-containing comonomers.

16. The copolymer of claim 13, further comprising up to 10 wt % of one or more functional comonomers selected from the group consisting of ethylenically unsaturated monocarboxylic and dicarboxylic acids, maleic anhydride, ethylenically unsaturated carboxamides and carbonitriles, ethylenically unsaturated sulfonic acids and salts thereof, epoxide-containing comonomers.

17. A process for preparing a copolymer of claim 11, comprising radically initiated polymerizing the vinyl chloride, vinyl acetate, and vinyl ester monomers.

18. The process of claim 17, wherein polymering is carried out in an aqueous medium.

19. A binder for paints and printing inks comprising at least one copolymer of claim 11.

20. A binder for coating materials for impregnating and/or coating paper, card, textiles, nonwovens, metals, mineral surfaces, wood, and plastics, comprising at least one copolymer of claim 11.

21. A coating material for producing a heat-sealable and RF-weldable film, comprising at least one copolymer of claim 11.
